(19) United States
(12) Patent Application Publication
(10) Pub. No.: US 2026/0120670 A1
(43) Pub. Date: Apr. 30, 2026

(54) POLYPHONIC PICKUP FOR STRINGED MUSICAL INSTRUMENT

(71) Applicant: Overman LLC, St. Paul, MN (US)

(72) Inventors: William Wyatt OVERMAN, St. Paul, MN (US); Jonathan P. FORSYTHE, St. Paul, MN (US)

(73) Assignee: Overman LLC, St. Paul, MN (US)

(21) Appl. No.: 18/934,201

(22) Filed: Oct. 31, 2024

(51) Int. Cl. G10H 3/14; G10D 3/00; G10H 1/18

(52) U.S. Cl. CPC G10H 3/143; G10D 3/00; G10H 1/18; G10H 2240/311

(57) ABSTRACT

A polyphonic pickup system includes a respective user-input device corresponding to each string of a stringed musical instrument. The system enables a user to select between two or more different audio channels for directing audio signals originating from different individual strings of the instrument.

### TECHNICAL FIELD

The present technology is generally related to stringed musical instruments.

### BACKGROUND

Stereophonic audio (or simply “stereo” audio) involves splitting an audio source into two or more individual electronic signals for output at different physical locations, in order to produce an enhanced “three-dimensional” (3-D) or “surround-sound” characteristic. As one example, a user's left earbud and right earbud can be configured to play a different portion of a song in each respective ear.

### SUMMARY OF THE DISCLOSURE

The techniques of this disclosure generally relate to systems and techniques for incorporating stereophonic audio between different strings of a stringed musical instrument, such as a guitar, bass guitar, cello, ukulele, viola, and the like. Specifically, the systems described herein enable a user to select a desired audio-output channel for each individual string, providing for a uniquely customizable listening experience.

Some examples of the present disclosure include a polyphonic pickup system for a stringed musical instrument, wherein the system includes: two or more audio-output devices; and, for each string of the musical instrument: a piezoelectric transducer configured to output an electric signal in response to receiving a sonic pressure wave from the string; and a user input device defining two or more selectable configurations, the user-input device being conductively coupled between the piezoelectric transducer and the two or more audio-output devices such that the selectable configurations of the user-input device define unique electricals connection between the piezoelectric transducer and each of the audio-output devices.

In some examples of this disclosure, a stringed musical instrument includes a polyphonic pickup system comprising: two or more audio-output devices; and, for each of a plurality of strings of the musical instrument: a piezoelectric transducer configured to output an electric signal in response to receiving a sonic pressure wave from the string; and a user input device defining two or more selectable configurations, the user-input device being conductively coupled between the piezoelectric transducer and the two or more audio-output devices such that the selectable configurations of the user-input device define unique electricals connection between the piezoelectric transducer and each of the audio-output devices.

In some examples of this disclosure, a polyphonic-pickup kit includes at least: a transducer saddle, a plurality of piezoelectric transducers; a plurality of single-pole-double-throw (SPDT) toggle switches; a rectangular toggle plate; two or more audio-output jacks; and optionally, a Musical Instrument Digital Interface (MIDI) output jack.

The details of one or more aspects of the disclosure are set forth in the accompanying drawings and the description below. Other features, objects, and advantages of the techniques described in this disclosure will be apparent from the description and the drawings, and from the claims.

### BRIEF DESCRIPTION OF THE DRAWINGS

The disclosure can be more completely understood in consideration of the following detailed description of various embodiments of the disclosure, in connection with the accompanying drawings, in which:

FIG. 1A is a front view of a stringed musical instrument including an integrated polyphonic pickup system.

FIG. 1B is a partial transparent view of the stringed musical instrument of FIG. 1A, showing some example internal components of the polyphonic pickup system.

FIG. 1C is a closeup view of an example of the polyphonic pickup system of FIGS. 1A & 1B.

FIG. 2A shows an example user-input device for the polyphonic pickup system of FIGS. 1A-1C while in a first selectable configuration.

FIG. 2B shows the user-input device of FIG. 2A while in a second selectable configuration.

FIG. 2C shows the user-input device of FIGS. 2A & 2B while in a third selectable configuration.

FIG. 3 is an example wiring diagram for the polyphonic pickup system of FIGS. 1A-1C.

FIG. 4A is a front view of the stringed musical instrument of FIGS. 1A & 1B, illustrating an example in which the polyphonic pickup system includes an optional musical instrument digital interface (MIDI) output device.

FIG. 4B is a partial transparent view of the stringed musical instrument of FIG. 4A, showing some example internal components of the polyphonic pickup system.

FIG. 4C is an example wiring diagram for the polyphonic pickup system of FIGS. 4A & 4B.

FIG. 5A is a front view of the stringed musical instrument of FIGS. 1A & 1B, illustrating an alternate placement for a control panel of the polyphonic pickup system.

FIG. 5B is a partial transparent view of the stringed musical instrument of FIG. 5A, showing some example internal components of the polyphonic pickup system.

FIG. 6 is a front view of the stringed musical instrument of FIGS. 1A & 1B, illustrating another alternate configuration for the control panel of the polyphonic pickup system.

FIG. 7 depicts a example kit for assembling a polyphonic pickup system within a stringed musical instrument.

FIG. 8 is a flowchart illustrating an example process or method for installing a polyphonic pickup system within a stringed musical instrument.

While examples of this disclosure are amenable to various modifications and alternative forms, specifics thereof shown by way of example in the drawings will be described in detail. It should be understood, however, that the intention is not to limit the disclosure to the particular examples described.

### DETAILED DESCRIPTION

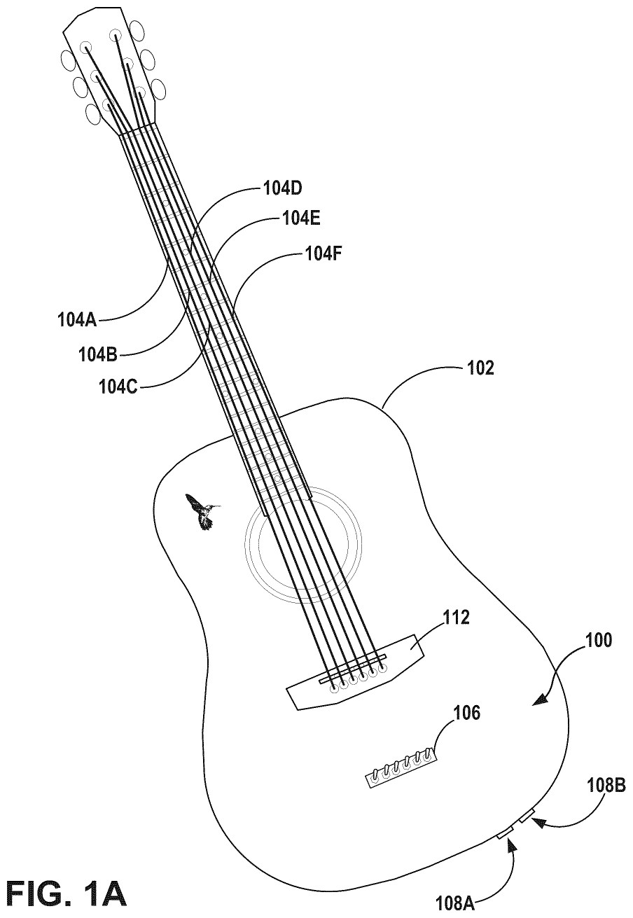

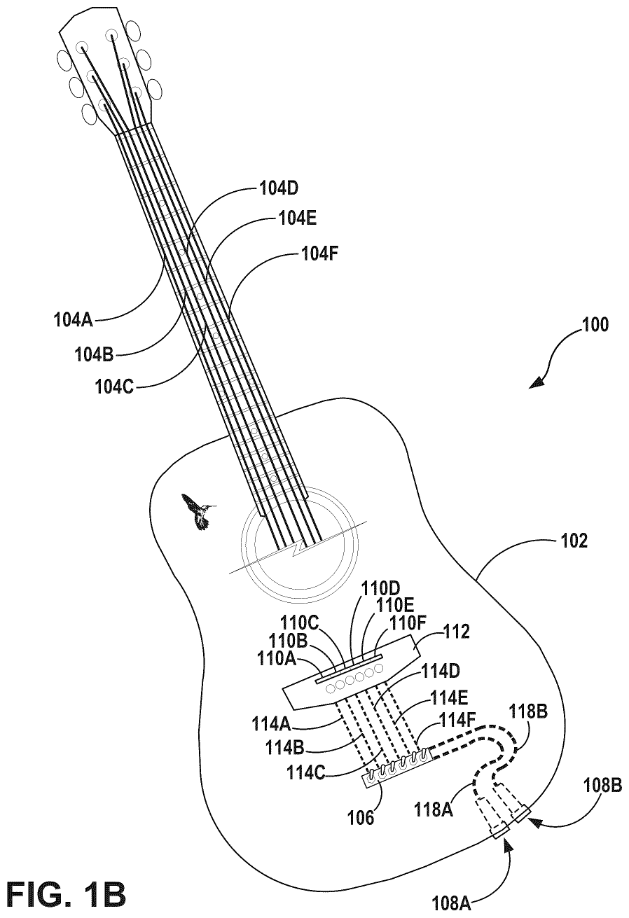

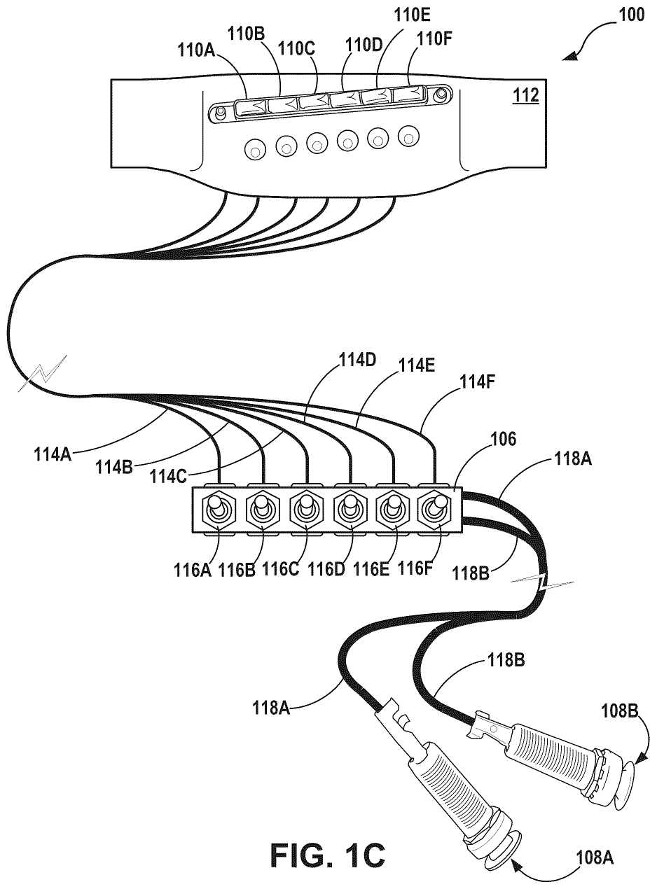

FIG. 1A is a front view of a stringed musical instrument with an integrated polyphonic pickup system 100, in accordance with the techniques of this disclosure. As used herein, the term “polyphonic” refers to the system's ability to provide independent control over multiple (i.e., two or more) sounds or audio signals simultaneously. In particular, the polyphonic pickup system described herein is configured to isolate and transmit the music produced by each string of a musical instrument, independently from every other string.

In the example shown in FIG. 1A, the stringed musical instrument is depicted as an acoustic guitar 102 having exactly six strings 104A-104F (collectively, “strings 104”). Accordingly, polyphonic system 100 constitutes a “hexaphonic” (i.e., six-sound) pickup system. However, it is to be understood, to those of ordinary skill in the art, that the techniques of this disclosure are similarly applicable to virtually any known class of stringed musical instrument, including, but not limited to: bass guitars, ukuleles, cellos, violins, violas, and fiddles (four strings each); banjos (four-to-six strings); mandolins (eight strings), balalaikas (three strings), veenas (four-to-eight strings), harps (nineteen-to-forty-seven strings), and even large, stationary stringed instruments such as pianos (230 strings).

Functionally, polyphonic pickup system 100 is configured such that a user (e.g., the guitar player) can individually select, for each string 104 of the instrument, a desired audio-output channel from two or more such channels. In this regard, polyphonic pickup system 100 can be considered to be part of a “stereophonic” audio system that additionally includes two or more speakers, earbuds, and/or other audio players (not shown) that may be connected to the audio-output channels of system 100.

In particular, system 100 includes a control panel 106 of user-inputs enabling the user to select either a first (or “left”) audio-output channel 108A or a second (or “right”) audio-output channel 108B to receive the electronic audio signal encoding the sound generated any one individual string 104, any combination or permutation of any subset of strings 104, all of strings 104, or none of strings 104. For instance, in some examples, the input devices 106 are each thirdly selectable (i.e., define a third selectable configuration besides “left” and “right”) that enables the user to “mute” the sound from any individual string 104 at will.

FIGS. 1B & 1C illustrate some additional internal components of polyphonic pickup system 100 of FIG. 1A. For instance, system 100 includes an array of audio transducers, or “pickup” devices 110A-110F, with each pickup device 110 corresponding to a respective string 104 of the guitar 102. For instance, in the present example, pickup devices 110 are aligned within the bridge 112 of the guitar 102, with each pickup device 110 positioned directly underneath a lower end of one of strings 104.

Each pickup device 110, when positioned immediately adjacent to its corresponding string 104, is configured to output a signal indicating when its string has been plucked and is producing sound. Typically (though not necessarily in all examples), pickup devices 110 each include a piezoelectric transducer that generates an electrical signal in response to the incident pressure wave of sonic energy when its string 104 is plucked.

Pickup system 100 further includes a plurality of conductive wires 114A-114F, with each conductive wire 114 corresponding to a respective pickup device 110 and a respective string 104. In some cases, each conductive wire 114 is integrally formed with its pickup device 110 coupled to its proximal end. In other cases, each conductive wire may be electrically coupled (e.g., soldered) to its pickup device's native embedded wire, and may be considered an extension thereof.

Pickup system 100 further includes a plurality of user-input devices 116A-116F, with each user-input device 116 corresponding to a respective conductive wire 114, a respective pickup device 110, and a respective string 104. That is, each user-input device 116 is electrically coupled to the distal end of its corresponding conductive wire 114, establishing a continuous electrical connection to the corresponding pickup device 110.

In general, each user-input device 114 can include any suitable component that is manually adjustable, selectable, convertible, or otherwise configurable between two or more well-defined states, positions, orientations, or configurations. Various example types of such components include switches, dials, push-buttons, levers, and even digital graphical objects of a graphical user interface (GUI) displayed on a touch-sensitive display (or “touchscreen”).

Regardless of the physical selection mechanism, input devices 116 are both individually and collectively wired such that each selectable configuration of the input device 116 defines a unique, continuous electrical connection from exactly one of strings 104 to one of audio-output devices 108, to none of audio-output devices 108, or to all of audio-output devices 108.

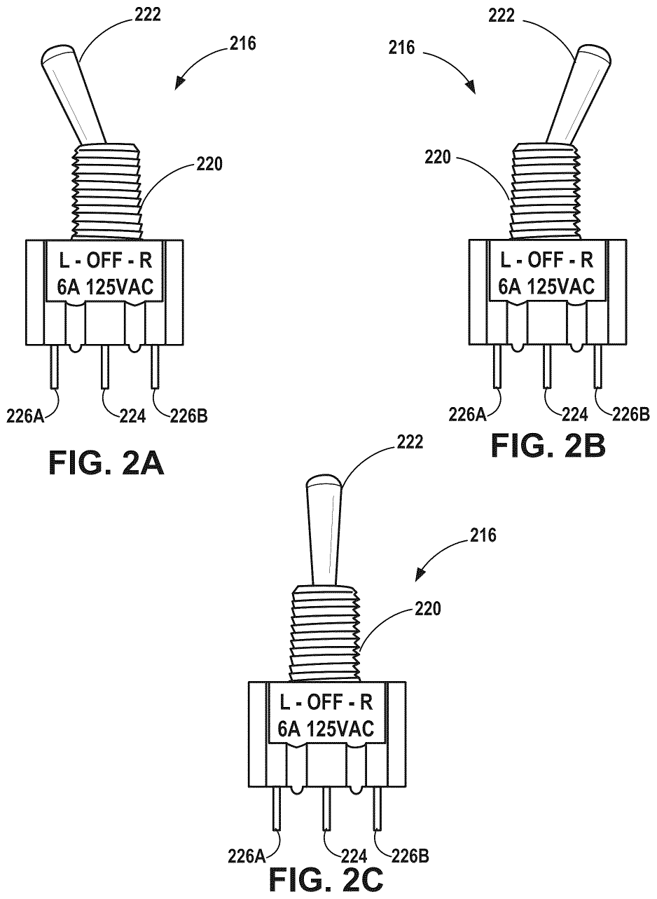

For illustrative purposes, in the non-limiting examples of the present disclosure, user-input devices 116 are generally shown and described in the form of single-pole-double-throw (“SPDT”) toggle switches 216, an example of which is shown in FIGS. 2A-2C. As shown in FIGS. 2A-2C, each SPDT toggle switch 216 includes a base portion 220 and an elongated lever or knob 222 extending upward therefrom. The elongated lever or knob 222 is configurable between three positions or orientations relative to the base: a “left” position (FIG. 2A), a “right” position (FIG. 2B), and a “middle” position (FIG. 2B).

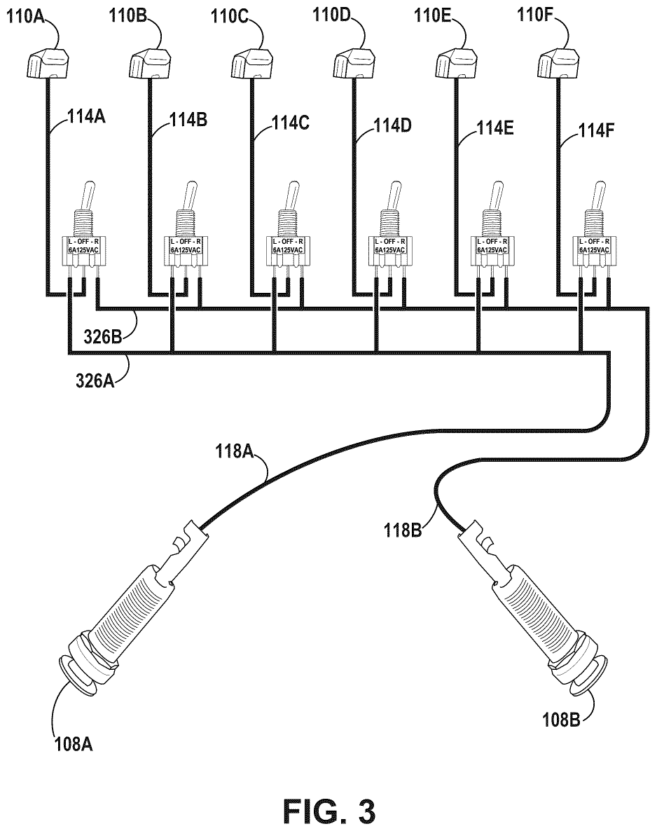

Each toggle switch 216 further includes one “input” prong 224, a “left” output prong 226A, and a “right” output prong 226B. FIG. 3 shows an example electrical wiring diagram enabling the functionality described herein. As shown in FIG. 3, the left prongs 226A are connected in parallel (326A) such that, when the knob 222 of any one toggle switch 216 is in the “left” position (FIG. 2A), that toggle switch 216 defines a continuous electrical connection between its pickup device 110 and the first (or “left”) audio-output jack 108A, via output wire 118A.

Similarly, the right prongs 22BA are connected in parallel (326B) such that, when the knob 222 of any one toggle switch 216 is 222 is in the “right” position (FIG. 2B), that toggle switch 216 defines a continuous electrical connection between its pickup device 110 and the second (or “right”) audio-output jack 108B, via output wire 118B. While the knob or lever 222 of an input device 216 is in the “middle” position (FIG. 2C), the corresponding conductive wire 114 is not coupled to either audio-output device 108, thereby functionally “cutting” or “muting” the corresponding string 104 of the guitar 102.

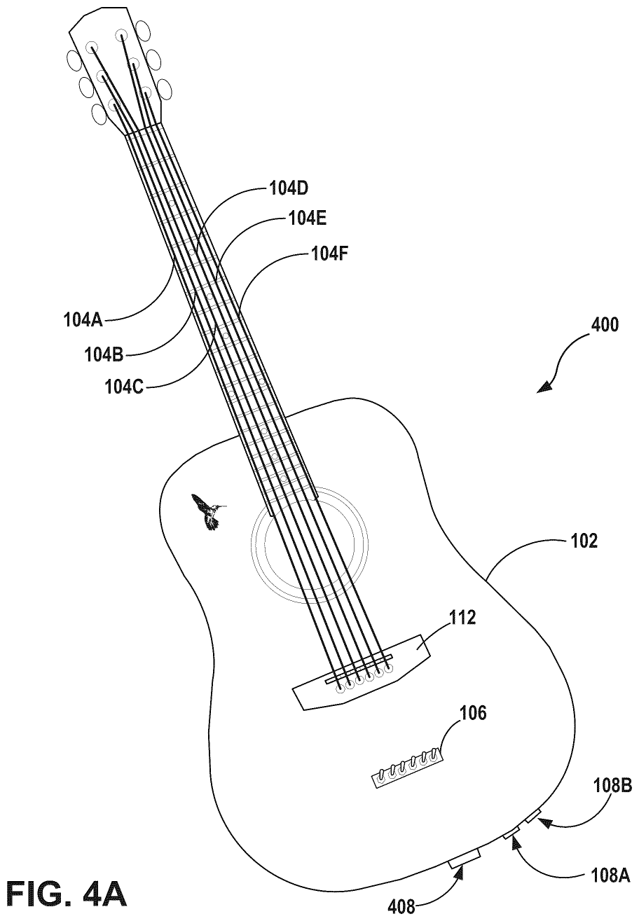

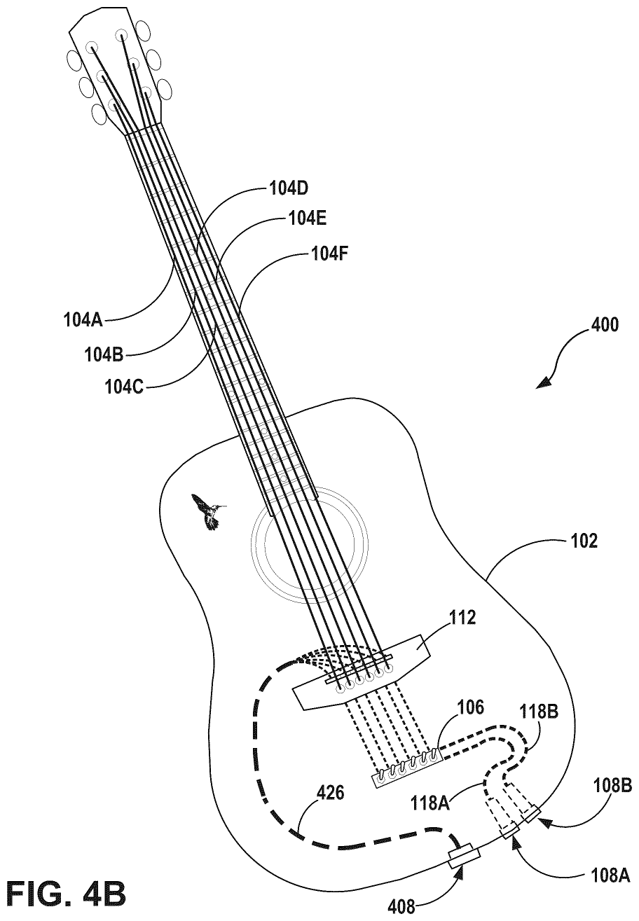

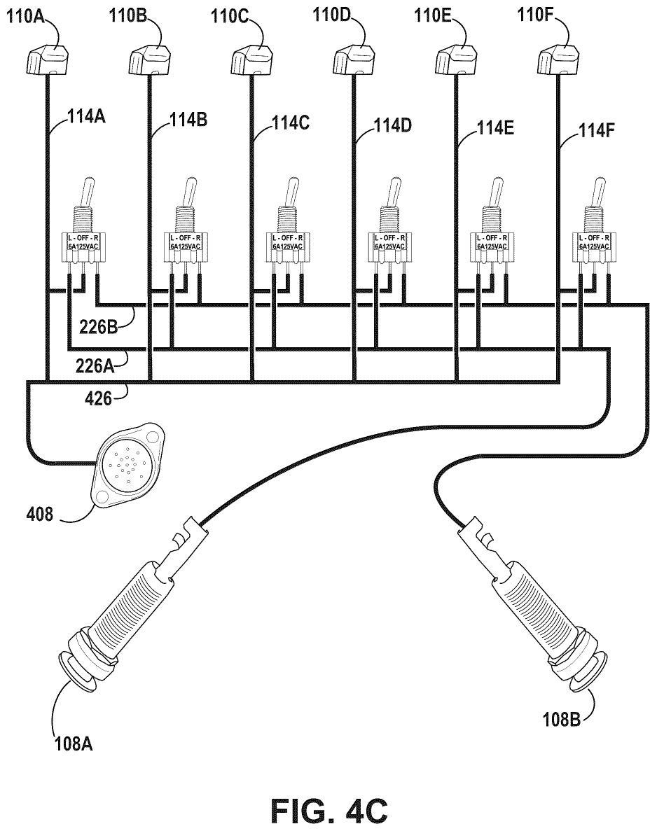

Polyphonic pickup system 100 can include more than two “selectable” audio-output channels 108, so long as user-input devices 116 define an appropriate number of selectable configurations to accommodate. Additionally, or alternatively, polyphonic pickup system 100 can include one or more “non-selectable” audio-output channels that are not individually controllable via input devices 116 of the control panel 106. For instance, FIGS. 4A-4C illustrate an example in which the polyphonic pickup system 400 includes an additional audio-output device 408. As shown, audio-output device 408 is wired in parallel (426) directly to the array of pickup devices 110, bypassing the control panel 106 entirely.

In some implementations, audio-output device 408 can include a standardized Musical Instrument Digital Interface (“MIDI”) output jack. Such devices are configured to be communicatively coupled to a suitable computing device running an instance of music-recording software. In some such cases, the player is able to use the digital controls within the recording software to perform the same or substantially similar functionality as the physical control panel 106.

For instance, with the appropriate music-recording software, the user can “direct” the audio from any one string 104 or multiple strings 104 toward any output channel 108 even without using the manual toggles 116/216. Additionally, in some instances of the appropriate recording software, the user can command the program to store one or more favorite audio-output permutations (e.g., “LLRLRL,” or “LLLLLR,” etc.) in digital memory for subsequent retrieval, and, for instance, to rapidly iterate between different preset permutations.

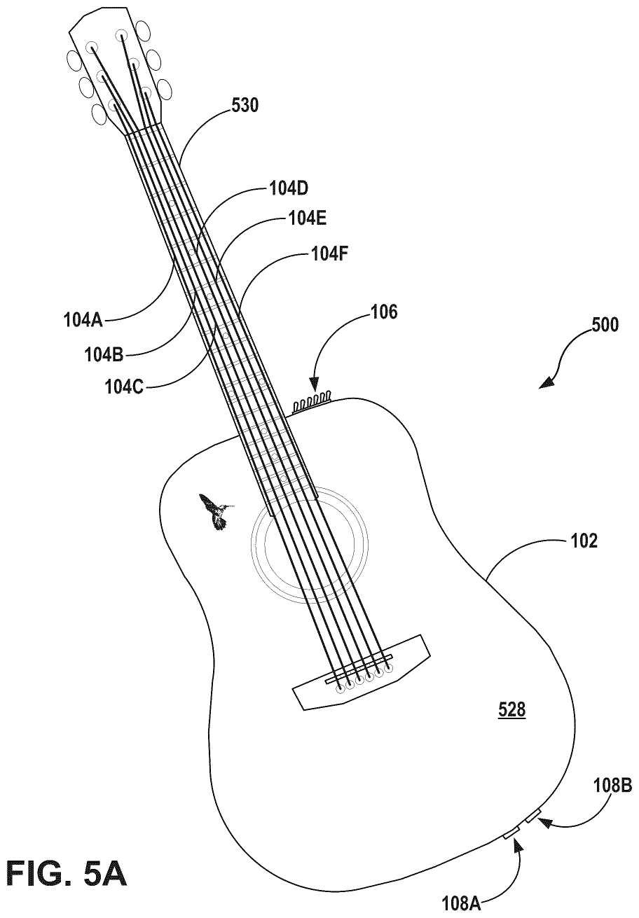

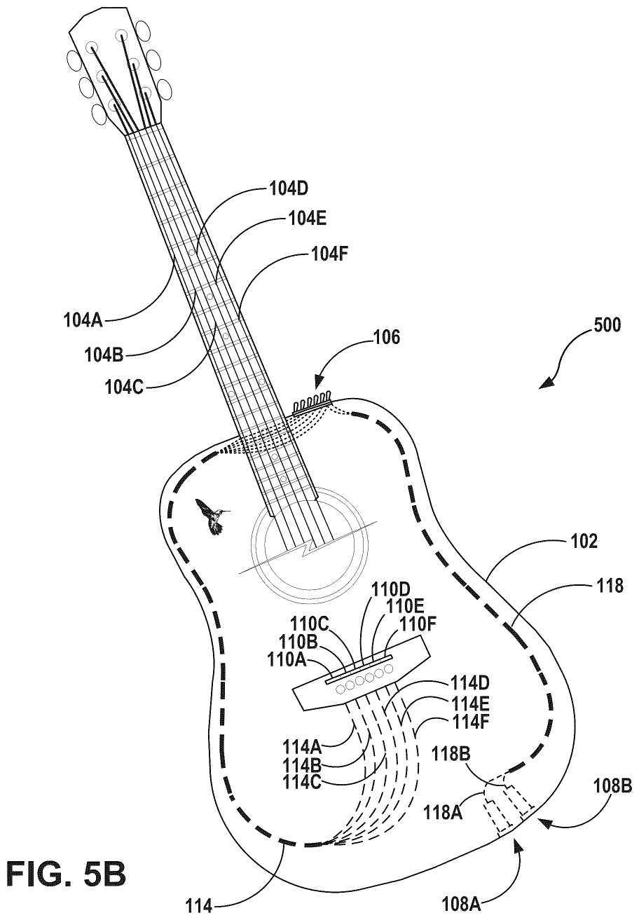

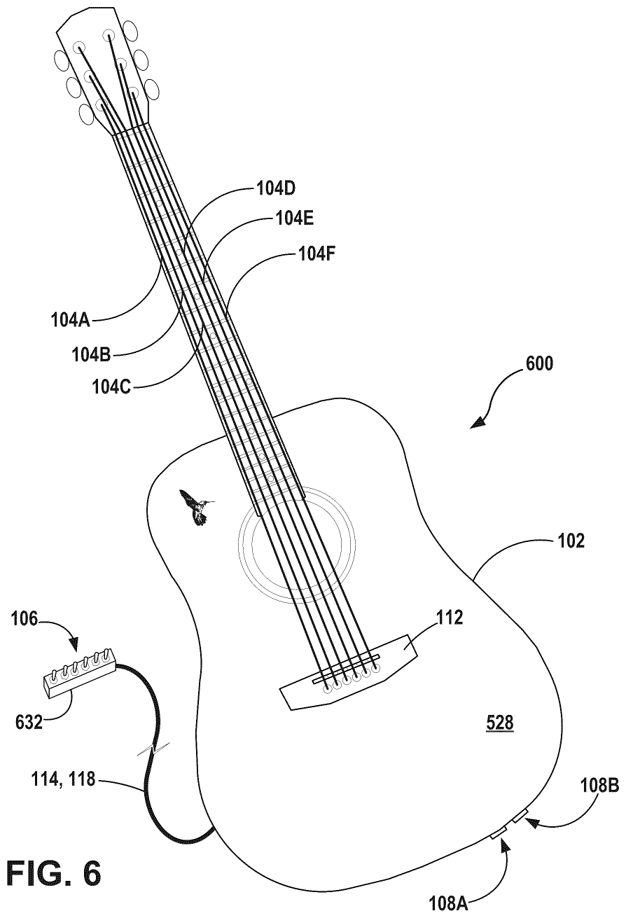

FIGS. 5A, 5B, & 6 illustrate examples of polyphonic pickup system 100 with alternate configurations for control panel 106. Control panel 106 can be mounted at any suitable location on the body 528 or neck 530 of the guitar 102 (or other stringed musical instrument). For instance, in the example shown in FIGS. 5A & 5B, control panel 106 is mounted on the side of the guitar, near where the neck 530 attaches to the body 528. In the example shown in FIG. 6, control panel 106 is not mounted externally onto the guitar 102, but rather, is part of a distinct, handheld “controller” device 632 connected to the guitar 102 via the relevant wiring 114/118 of a convenient length. In other examples, the controller device 632 can be a fully remote control, configured to wirelessly transmit signals to a corresponding transceiver (not shown) integrated within the pickup system 600 within the guitar 102.

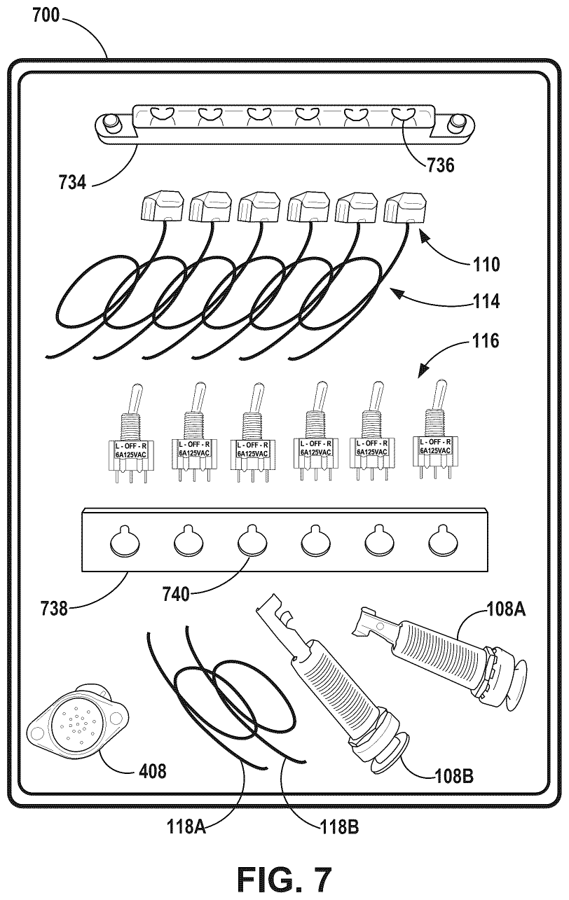

FIG. 7 depicts an example kit 700 for assembling a polyphonic pickup system within a stringed musical instrument 102 (FIG. 1A), in accordance with any or all of the examples described above. As shown in FIG. 7, kit 700 includes: a pickup-transducer saddle 734 defining a number of slots 736 equal to the number of strings 104 of the musical instrument 102; a plurality of pickup devices 110 (e.g., piezoelectric transducers) corresponding to the number of strings 104 of the musical instrument 102; a plurality of conductive wires 114, which may or may not be integrally formed with the respective pickup devices 110; a plurality of user-input device 116, such as SPDT toggle switches, corresponding to the number of strings 104 of the musical instrument 102; a rectangular plate 738 defining a number of apertures 740 corresponding to the number of strings 104 of the intended musical instrument 102; and two or more audio-output jacks 108A, 108B with corresponding output wiring 118A, 118B. In some examples, but not all examples, kit 700 further includes a MIDI output port 408.

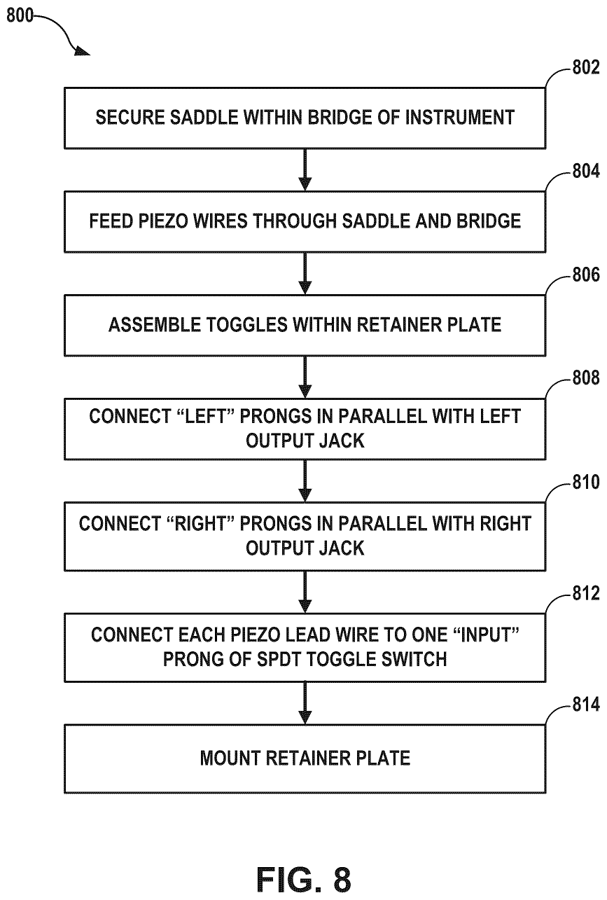

FIG. 8 is a flowchart illustrating an example method for assembling a polyphonic pickup system within a stringed musical instrument, in accordance with the techniques described herein, and with reference to the examples described above.

Step 802 includes securing an audio-pickup saddle 734 within the bridge 112 of the instrument 102. At Step 804, conductive wires coupled to audio-pickup device 110 (e.g., piezoelectric transducers) are fed through corresponding slots 736 of the saddle 734 and through the bridge 112 of the instrument 102, such that the pickup device 110 are aligned within the saddle 734.

Step 806 includes assembling a plurality of user-input devices 116, such as SPDT toggle switches 216, within respective apertures 740 of a retainer plate 738. Once secured, at Step 808, the “left” output prongs 226A of the plurality of input devices 116 are conductively coupled in parallel (326A) with a first audio-output device 108A. Similarly, at Step 810, the “right” output prongs 226B of the input devices 116 are conductively coupled in parallel (326B) with a second audio-output device 108B.

At Step 812, each conductive wire 114 is conductively coupled (e.g., soldered) to the “input” prong 224 of a respective input device 116, such as an SPDT toggle switch 216. Finally, at Step 814, the retainer plate 738 is secured to the body 528 or neck 530 of the instrument 102.

The various examples recited above have been chosen, described, and illustrated so that persons skilled in the art will be able to understand the invention and the manner and process of making and using it. The descriptions and the accompanying drawings should be interpreted in the illustrative and not the exhaustive or limited sense. The invention is not intended to be limited to the exact forms disclosed. While the application attempts to disclose all of the embodiments of the invention that are reasonably foreseeable, there may be unforeseeable insubstantial modifications that remain as equivalents. It should be understood by persons skilled in the art that there may be other embodiments than those disclosed which fall within the scope of the invention as defined by the claims. Where a claim, if any, is expressed as a means or step for performing a specified function it is intended that such claim be construed to cover the corresponding structure, material, or acts described in the specification and equivalents thereof, including both structural equivalents and equivalent structures, material-based equivalents and equivalent materials, and act-based equivalents and equivalent acts.

What is claimed is:

1. A polyphonic pickup system for a musical instrument having a plurality of strings, the system comprising:
two or more audio-output devices; and
for each string of the plurality of strings of the musical instrument:
a piezoelectric transducer configured to output an electric signal in response to receiving a sonic pressure wave from the string; and
a user-input device defining two or more selectable configurations, the user-input device being conductively coupled between the piezoelectric transducer and the two or more audio-output devices such that the selectable configurations of the user-input device define unique electricals connection between the piezoelectric transducer and each of the audio-output devices.

2. The system of claim 1, wherein each user-input device comprises a single-pole-double-throw (SPDT) toggle switch.

3. The system of claim 2, further comprising a rectangular retainer plate configured to align and retain the plurality of SPDT toggle switches.

4. The system of claim 1, further comprising a saddle configured to align and retain the plurality of piezoelectric transducers.

5. The system of claim 4, further comprising a wooden bridge defining an elongated central slot configured to retain the saddle.

6. The system of claim 1, further comprising a Musical Instrument Digital Interface (MIDI) output jack conductively coupled in parallel to the plurality of piezoelectric transducers.

7. The system of claim 6, wherein the MIDI output jack is not conductively coupled to the plurality of user-input devices.

8. A stringed musical instrument comprising a polyphonic pickup system, the system comprising:
two or more audio-output devices; and
for each of a plurality of strings of the stringed musical instrument:
a piezoelectric transducer configured to output an electric signal in response to receiving a sonic pressure wave from the string; and
a user-input device defining two or more selectable configurations, the user-input device being conductively coupled between the piezoelectric transducer and the two or more audio-output devices such that the selectable configurations of the user-input device define unique electricals connection between the piezoelectric transducer and each of the audio-output devices.

9. The system of claim 8, wherein the stringed musical instrument comprises a guitar, and wherein the plurality of strings comprises six strings.

10. The system of claim 8, wherein the stringed musical instrument comprises a bass guitar or a ukulele, and wherein the plurality of strings comprises four strings.

11. The system of claim 8, wherein each user-input device comprises a single-pole-double-throw (SPDT) toggle switch.

12. The system of claim 11, further comprising a rectangular retainer plate configured to align and retain the plurality of SPDT toggle switches.

13. The system of claim 8, wherein the plurality of user-input devices is mounted to an exterior of the stringed musical instrument.

14. The system of claim 13, wherein the plurality of user-input devices is mounted on a top of the musical instrument below a bridge of the musical instrument.

15. The system of claim 8, wherein the plurality of user-input devices is not mounted to an exterior of the stringed musical instrument and is coupled to the stringed musical instrument via a wired connection.

16. The system of claim 8, further comprising a saddle configured to align and retain the plurality of piezoelectric transducers.

17. The system of claim 16, wherein a bridge of the musical instrument defines a central elongated slot, and wherein the saddle is mounted within the central elongated slot of the bridge.

18. The system of claim 8, further comprising a Musical Instrument Digital Interface (MIDI) output jack conductively coupled to the plurality of piezoelectric transducers.

19. The system of claim 18, wherein the MIDI output jack is not conductively coupled to the plurality of user-input devices.

20. A polyphonic-pickup kit for a stringed musical instrument, the kit comprising:
a transducer saddle;
a plurality of piezoelectric transducers;
a plurality of single-pole-double-throw (SPDT) toggle switches;
a rectangular toggle plate;
a first audio-output jack; and
a second audio-output jack.
